(19) United States
(12) Patent Application Publication
(10) Pub. No.: US 2025/0272662 A1
(43) Pub. Date: Aug. 28, 2025

(54) SYSTEMS AND METHODS FOR ADAPTING A SCHEDULE FOR OPERATION OF AN AIRCRAFT BASED ON HOLDING TIME

(71) Applicant: THE BOEING COMPANY, Arlington, VA (US)

(72) Inventors: Akshay Arun Sankeshwari, Bangaluru (IN); Ajaya Srikanta Bharadwaja, Bangalore (IN); Ganesh Shabadi, Bangalore (IN); Umesh Hosamani, Bangalore Jarnataka (IN)

(73) Assignee: THE BOEING COMPANY, Arlington, VA (US)

(21) Appl. No.: 18/590,208

(22) Filed: Feb. 28, 2024

(51) Int. Cl. G06Q 10/1093; B64D 45/00

(52) U.S. Cl. CPC G06Q 10/1097; B64D 45/00

(57) ABSTRACT

A system and a method include a control unit configured to determine an average holding time in relation to an arrival airport where an aircraft is scheduled to arrive. The control unit is further configured to determine one or more different schedule options for the aircraft based on the average holding time. The one or more different schedule options differ in at least one respect from an original schedule.

### FIELD OF THE DISCLOSURE

Examples of the present disclosure generally relate to systems and methods for adapting a schedule for operation of an aircraft based on a holding time of one or more other aircraft.

### BACKGROUND OF THE DISCLOSURE

Aircraft are used to transport passengers and cargo between various locations. Numerous aircraft depart from and arrive at a typical airport every day.

An aircraft generally operates according to a predetermined flight plan between a departure airport and a destination airport. The flight plan includes a path from the departure airport to the destination airport, and may also include a flight time between the locations.

For various reasons, commercial, business, and general aviation aircraft may be diverted from a flight plan. For example, inclement weather may cause an air traffic controller to divert an aircraft from a flight plan. Due to inclement weather (such as rain or snow), visibility at a destination airport may be limited. Accordingly, an air traffic controller may then determine that separation times between landing aircraft need to be increased. As another example, flight congestion at a destination airport may also cause the air traffic controller to divert an aircraft from a flight plan into a holding pattern.

An aircraft may be diverted into a holding pattern, which deviates from the flight plan, in order to accommodate landing delays at a particular destination airport, whether due to inclement weather, flight congestion, and/or the like. Most holdings occur during an arrival phase of flight, and at lower altitudes than a cruise phase. An aircraft holding at such lower altitudes increases fuel consumption, thereby increasing operational cost and emissions. Further, various aircraft in holding patterns increase air traffic congestion in relation to an airport, and also increase workload for pilots, as well as aircraft traffic controllers. Also, additional time of flight due to a holding pattern can increase passenger anxiety.

### SUMMARY OF THE DISCLOSURE

A need exists for a system and a method for reducing holding times for aircraft. Further, a need exists for a system and a method for increasing operational efficiency of an aircraft.

With those needs in mind, certain examples of the present disclosure provide a system including a control unit configured to determine an average holding time in relation to an arrival airport where an aircraft is scheduled to arrive. The control unit is also configured to determine one or more different schedule options for the aircraft based on the average holding time. The one or more different schedule options differ in at least one respect from an original schedule.

The aircraft is operated according to the one or more different schedule options.

The system also includes a user interface including a display. The control unit is configured to present the one or more different schedule options on the display. In at least one example, the user interface is onboard the aircraft.

The control unit can be further configured to automatically select the one or more different schedule options for the aircraft.

The control unit can be further configured to automatically operate the aircraft according to the one or more different schedule options.

In at least one example, the control unit is further configured to determine one or more alterations to one or more aspects of the aircraft during flight based on the average holding time. For example, the one or more aspects include airspeed. The control unit can be further configured to present one or more indicators on a display. The one or more indicators show the one or more alterations.

The control unit can be an artificial intelligence or machine learning system.

Certain examples of the present disclosure provide a method including determining, by a control unit, an average holding time in relation to an arrival airport where an aircraft is scheduled to arrive; and determining, by the control unit, one or more different schedule options for the aircraft based on the average holding time, wherein the one or more different schedule options differ in at least one respect from an original schedule.

Certain examples of the present disclosure provide a non-transitory computer-readable storage medium comprising executable instructions that, in response to execution, cause one or more control units comprising a processor, to perform operations comprising: determining an average holding time in relation to an arrival airport where an aircraft is scheduled to arrive; determining one or more different schedule options for the aircraft based on the average holding time, wherein the one or more different schedule options differ in at least one respect from an original schedule; presenting the one or more different schedule options on a display of the aircraft; determining one or more alterations to one or more aspects of the aircraft during flight based on the average holding time; and presenting one or more indicators on a display, wherein the one or more indicators show the one or more alterations.

### BRIEF DESCRIPTION OF THE DRAWINGS

FIG. 1 illustrates a block diagram of a system, according to an example of the present disclosure.

FIG. 2 illustrates a flow chart of a method, according to an example of the present disclosure.

FIG. 3 illustrates a front view of a display, according to an example of the present disclosure.

FIG. 4 illustrates a front view of a display, according to an example of the present disclosure.

FIG. 5 illustrates a schematic block diagram of a control unit, according to an example of the present disclosure.

FIG. 6 illustrates a perspective front view of an aircraft, according to an example of the present disclosure.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

Examples of the present disclosure provide systems and methods for strategically and tactically modifying a flight plan to increase operational efficiency, while reducing operational cost and emissions of an aircraft. The systems and methods described herein reduce arrival delays for aircraft by optimizing a cost and/or time index. For example, the systems and methods can modify an enroute flight profile to absorb delays in an enroute phase (at optimal altitudes) and/or by modifying an estimated off block time, for example. The systems and methods described herein allow aircraft operators to make informed decisions to modify flight plans in order to reduce fuel consumption, and in turn increase operational efficiency.

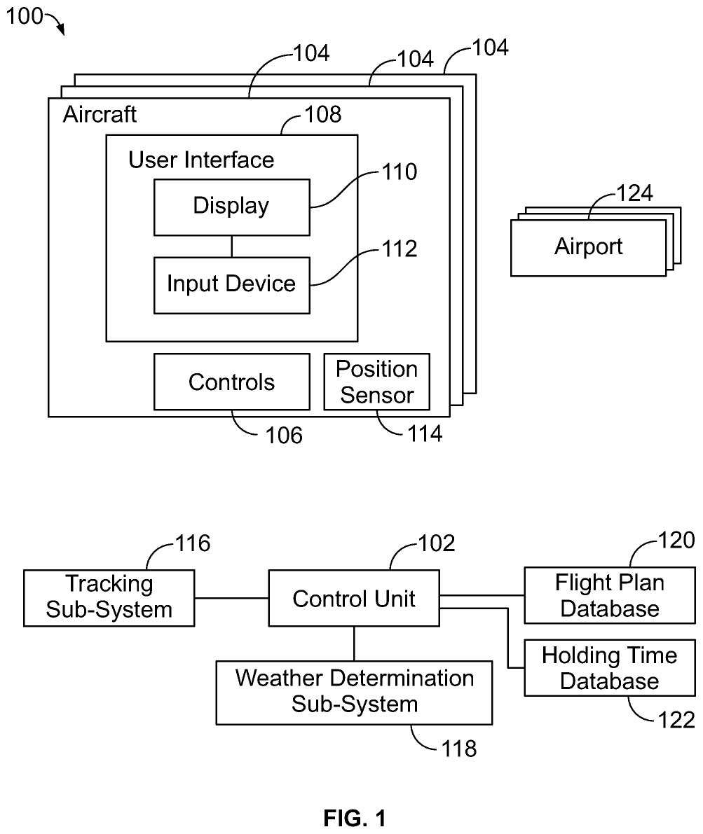

FIG. 1 illustrates a block diagram of a system 100, according to an example of the present disclosure. The system 100 includes a control unit 102 in communication with one or more aircraft 104, which travel between one or more departure airports and one or more arrival airports.

Each aircraft 104 includes controls 106 configured to allow an operator, such as a pilot, to control operation of the aircraft 104. For example, the controls 106 include one or more of a control handle, yoke, joystick, control surface controls, accelerators, decelerators, and/or the like.

The aircraft 104 also includes a user interface 108, such as within a flight deck or cockpit of the aircraft 104. The user interface 108 includes a display 110 and an input device 112. The display 110 can be a monitor, screen, television, touchscreen, and/or the like. The input device 112 can include a keyboard, mouse, stylus, touchscreen interface (that is, the input device 112 can be integral with the display 110), and/or the like. The user interface 108 can be, or part of, a computer workstation. For example, the user interface 108 can be part of a flight computer within the flight deck or cockpit of the aircraft 104. As another example, the user interface 108 can be a handheld device, such as a smart phone, tablet, or the like.

The aircraft 104 also includes a position sensor 114, which outputs position signals. The position sensor 114 allows the aircraft 104 to be tracked by a tracking sub-system 116.

The control unit 102 is in communication with the tracking sub-system 116, the aircraft 104 (such as with the user interface 108), a weather determination sub-system 118, a flight plan database 120, and a holding time database 122, such as through one or more communication connections. For example, the control unit 102 can communicate with the tracking sub-system 116, the aircraft 104, the weather determination sub-system 118, the flight plan database 120, and the holding time database 122 through one or more antennas, transceivers, radios, and/or the like.

The control unit 102 can be separate and distinct from the aircraft 104. For example, the control unit 102 can be at a central monitoring location, such as at an airport, or a location that is remote from the airport. The control unit 102 can be co-located with one or more of the tracking sub-system 116, the weather determination sub-system 118, the flight plan database 120, and/or the holding time database 122. As another example, the control unit 102 can be remotely located from the tracking sub-system 116, the weather determination sub-system 118, the flight plan database 120, and/or the holding time database 122. In at least one other example, the control unit 102 can be onboard an aircraft 104.

In at least one example, the control unit 102 can also be in communication with the controls 106 of the aircraft 104, and configured to automatically operate the controls 106, as described herein. Optionally, the control unit 102 may not be in communication with the controls 106, and may not be configured to automatically operate the aircraft 104.

The tracking sub-system 116 is configured to track positions of the aircraft 104 in real time. In at least one example, the tracking sub-system 116 is a radar sub-system. As another example, the tracking sub-system 116 is an automatic dependent surveillance-broadcast (ADS-B) tracking sub-system. Real time positions of the aircraft 104 on the ground and within an airspace are detected by the tracking sub-system 116 that receives position signals output by the position sensors 114 of the various aircraft 104. For example, the tracking sub-system 116 receives ADS-B signals output by the position sensors 114 of the various aircraft 104. As another example, the position sensors 114 can be global positioning system sensors. The position sensors 114 output signals indicative of one or more of the position, altitude, heading, acceleration, velocity, and/or the like of the various aircraft 104. The signals are received by the tracking sub-system 116. The tracking sub-system 116 is configured to track a current position of the aircraft 104 and other aircraft, such as proximate to (such as within 150 miles or less of) a destination airport.

The weather determination sub-system 118 is configured to determine current weather conditions at and proximate to the destination airport. The weather determination sub-system 118 communicates the current weather at and proximate to one or more destination airports to the control unit 102. For example, the weather determination sub-system 118 may be a meteorological and weather service that is in communication with the control unit 102. In at least one other example, the weather determination sub-system 118 may be an independent weather determination and forecasting system and/or service. For example, the weather determination sub-system 118 may include one or more Doppler radar installations. Optionally, the system 100 may not include the weather determination sub-system 118.

The control unit 102 can be configured to determine holding times of aircraft proximate to an airport. For example, the control unit 102 can analyze the tracked positions of the aircraft 104 (such as via tracking data received from the tracking sub-system 116) to determine that each aircraft 104 is in a holding pattern. The control unit 102 can determine a holding time for each aircraft 104 in relation to an airport 124 (for example, a destination or arrival airport where the aircraft 104 are scheduled to land). The control unit 102 can then determine an average holding time for the various aircraft 104 in relation to the airport 124. In at least one other example, the holding times for the aircraft 104 can be determined by the control unit 102 and/or another system or entity, and stored in the holding time database 122. The holding time database 122 can store the holding times for the aircraft 104 in relation to the airport 124. The control unit 102 can then determine the average holding time for the various aircraft 104 from the stored holding times within the holding time database 122. Optionally, the average holding time can be determined and stored in the holding time database 122.

The flight plan database 120 stores flight plans for the aircraft 104. For example, the flight plan for an aircraft 104 includes a departure time from a first airport (such as a departure airport), an arrival time at a second airport (such as an arrival airport—the airport 124), a flight path between the airports, flight speeds, altitudes, and the like during the different phases of flight, and/or the like. The control unit 102 receives the flight plans for the aircraft 104 from the flight plan database 120. Optionally, the control unit 102 receives the flight plans for the aircraft 104 from a monitoring center, air traffic control, and/or the like.

In operation, before an aircraft 104 departs from a departure airport to an arrival airport, the control unit 102 receives the flight plan for the aircraft 104. The flight plan includes an original schedule, which includes a scheduled departure time from the departure airport, and a scheduled arrival time at the arrival airport. The control unit 102 can further determine an amount of fuel onboard the aircraft 104, such as through a flight computer of the aircraft 104, and an amount of fuel that will be consumed (for example, burned) during the flight between the airports.

The control unit 102 further determines an average holding time for other aircraft 104 that have previously landed at the destination airport, as well as aircraft 104 awaiting to land at the destination airport, such as from data received from the holding time database 122, and/or a flight monitoring entity, such as air traffic control. The control unit 102 then determines an average holding time for other aircraft, such as aircraft that have already landed, and/or are to land, at the destination airport. The control unit 102 can then determine average fuel consumption for the average holding time for the aircraft 104. For example, based on data received from the flight computer of the aircraft 104, the control unit 102 can determine the average fuel consumption for the average holding time for a particular aircraft 104.

The control unit 102 continually monitors the average holding time in relation to an airport where the aircraft 104 is scheduled to land. The average holding time can vary based on scheduled air traffic at the airport. As such, the control unit 102 can then determine different flight schedule options (which differ from an original flight schedule) for the aircraft 104 based on the average holding time at different times. The control unit 102 can then present the different flight schedule options on the display 110 of the aircraft 104 to allow a pilot to select a different option, such as to reduce fuel consumption, and improve operational efficiency. In this manner, a flight schedule can be adapted (for example, one or more aspects being altered, changed, or the like) based on an average holding time in relation to an airport 124, such as a destination airport where the aircraft 104 is scheduled to arrive. The pilot can then select the different flight schedule option, and fly the aircraft according to the different flight schedule option.

In at least one example, the control unit 102 can automatically operate the aircraft 104 (such as via the controls 106) based on the selected different flight schedule option. Optionally, the control unit 102 may not be configured to automatically operate the aircraft 104.

In at least one example, the control unit 102 can also adapt a flight schedule (whether an original flight schedule, or a selected different schedule option) when the aircraft 104 is in flight and enroute to the destination airport. For example, based on the average holding time in relation to the airport, the control unit 102 can determine that a holding time for the aircraft 104 in flight will be less if the aircraft 104 alters one or more aspects during the flight. For example, the control unit 102 can determine that a holding time for the aircraft 104 will be less if the aircraft flies at a modified airspeed, modified altitude, and/or a modified path enroute to the airport. The control unit 102 can provide one or more indicators, such as a graphic, text, and/or the like, on the display 110 to show a suggested alteration to operation of the aircraft 104. The pilot can then select the suggested alteration and operate the aircraft 104 according to the suggested alteration.

In at least one example, the control unit 102 can automatically operate the aircraft 104 based on a selected suggested alteration. In at least one other example, the control unit 102 can automatically select an alteration to a flight schedule based on fuel savings as determined from an average holding time. Optionally, the control unit 102 may not automatically operate the aircraft 104, nor automatically select an alteration to a flight schedule.

As described herein, the system 100 includes the control unit 102, which is configured to determine an average holding time in relation to an arrival airport (for example, airport 124) where the aircraft 104 is scheduled to arrive. The control unit 102 is further configured to determine one or more different schedule options for the aircraft 104 based on the average holding time. The different schedule option(s) differ in at least one respect from an original schedule. The aircraft is operated based on the one or more different schedule options, whether selected by an operator (such as a pilot), or automatically selected by the control unit 102.

The control unit 102 is further configured to present the different schedule option(s) on the display 110. In at least one example, the display 110 is onboard the aircraft 104.

The control unit 102 can be further configured to automatically select the different schedule option(s) for the aircraft. The control unit 102 can be further configured to automatically operate the aircraft 104 according to the different schedule option(s).

In at least one example, the control unit 102 is further configured to determine one or more alterations (for example, recommended or suggested changes) to one or more aspects of the aircraft 104 during flight based on the average holding time. For example, the aspect(s) can include airspeed, and the alteration(s) can include decreasing or increasing airspeed. The control unit 102 can be further configured to present one or more indicators on the display 110. The indicator(s) show the alteration(s).

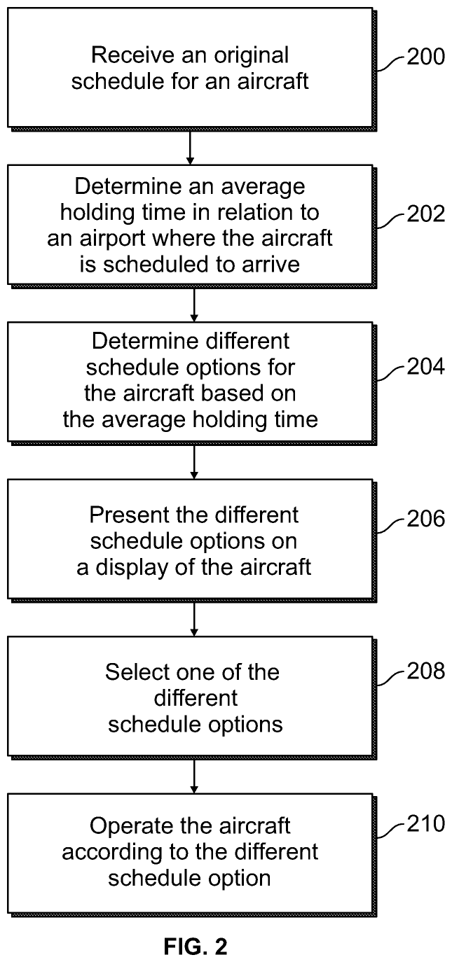

FIG. 2 illustrates a flow chart of a method, according to an example of the present disclosure. Referring to FIGS. 1 and 2, at 200, the control unit 102 receives an original schedule for an aircraft 104. The original schedule is an originally determined schedule (including a departure time from a departure airport, and an arrival time at an arrival airport), a holding time proximate to the arrival airport, and/or the like. The original schedule can further include various aspects for a flight between the departure airport and the arrival airport, such as an airspeed, altitude, and flight path for the aircraft 104 during the various phases of flight.

At 202, the control unit 102 determines an average holding time in relation to the arrival airport where the aircraft 104 is scheduled to arrive (that is, the arrival airport). For example, the average holding time is determined with respect to other aircraft that have landed and/or are scheduled to arrive at the airport. The average holding time is determined from previous aircraft that arrived at the arrival airport, aircraft in flight that are scheduled to arrive at the arrival airport, and/or the like. The average holding time can be based on a predetermined time period (such as within 1-10 hours, a day, a week, or the like), a predetermined number of aircraft scheduled to land (such as 5, 10, 20, 50, or more other aircraft that are scheduled to land before the aircraft 104), and/or the like.

At 204, the control unit 102 then determines different schedule options for the aircraft 104 based on the average holding time. The different schedule options include one or more aspects that differ from those in the original schedule. The aspects can include departure time, arrival time, holding time, airspeed during or more phases of flight, altitude during one or more phases of flight, a flight path during one or more phases of flight, and/or the like.

At 206, the control unit 102 presents the different schedule options on the display 110 of the aircraft 104. The control unit 102 can also show the original schedule on the display 110 to show differences with the different schedule options.

At 208, one of the different schedule options is selected. For example, a pilot can select a different schedule option. As another example, the control unit 102 can automatically select a different schedule option (such as can optimally reduce fuel consumption, time of flight, and/or the like).

At 210, the aircraft 104 is operated according to the different schedule option 210 to arrive at the arrival airport. For example, the pilot can operate the aircraft 104 according to the different schedule option. As another example, the control unit 102 can automatically operate the aircraft 104 according to the different schedule option.

Steps 200-208 can occur before the aircraft 104 departs from a departure airport. After the aircraft 104 is enroute to the destination airport, one or more aspects of the schedule (whether the original schedule or a different schedule option) can also be altered based on the average holding time proximate to the destination airport.

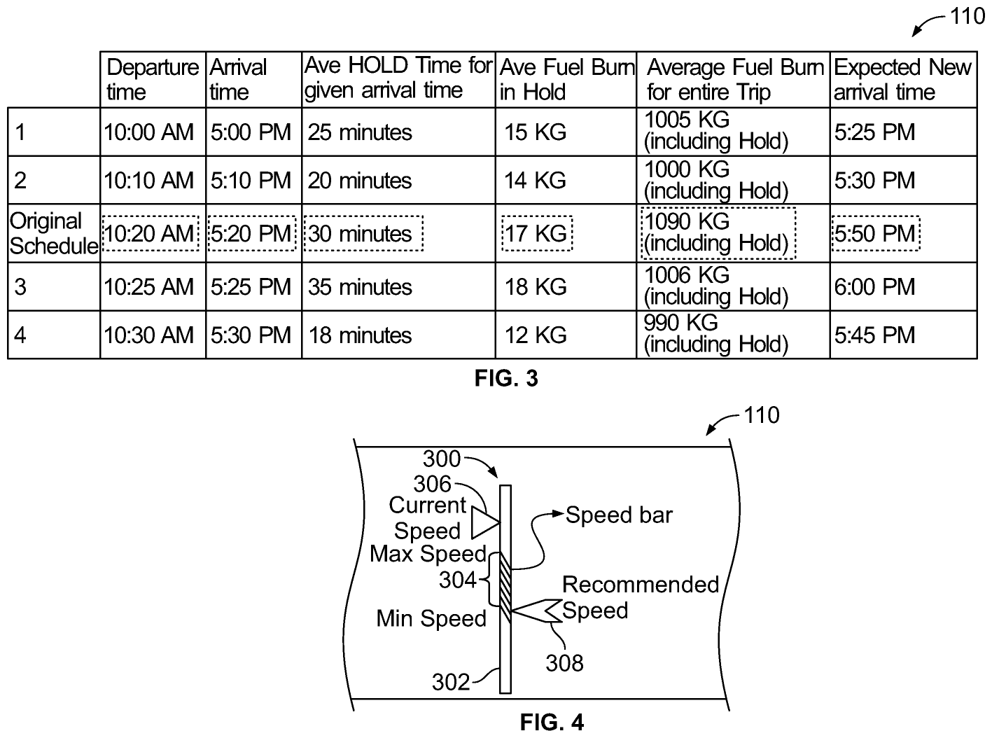

FIG. 3 illustrates a front view of a display 110, according to an example of the present disclosure. Referring to FIGS. 1-3, the control unit 102 presents (for example, shows) the original schedule and a plurality of different schedule options on the display 110. As shown, four different schedule options are presented. Optionally, the control unit 102 can determine and present less different schedule options (such as 1, 2, or 3), or more different schedule options (such as 5, 6, or more). For each of the original schedule and the different schedule options, the control unit 102 shows one or more aspects, such as a scheduled departure time from a departure airport, a scheduled arrival time (if no holding) at an arrival airport, an average holding time for a given arrival time, an average fuel consumption (for example, burn) during the average holding time, an average fuel burn for an entire trip, and an expected new arrival time given the average holding time. The control unit 102 can present more or less aspects than shown. It is to be understood that FIG. 3 shows an example, and is not limiting.

FIG. 4 illustrates a front view of a display 110, according to an example of the present disclosure. Referring to FIGS. 1-4, during a flight, the control unit 102 can present an indicator 300, which can be or otherwise include a graphic and/or text. As shown, in at least one example, the indicator 300 can be or otherwise include a bar 302 related to an airspeed. The indicator 300 can also include text. As another example, the indicator 300 can be just text. As another example, the indicator 300 can be a dial. As another example, the indicator 300 can be a gauge.

As shown, the indicator 300 includes a suggested airspeed range 304, which can show an upper limit (such as maximum airspeed), and a lower limit (such as minimum airspeed) for the aircraft 104. The indicator 300 can also show a current airspeed 306, as well as a recommended airspeed 308. The control unit 102 determines the suggested airspeed range 304, and/or the recommended airspeed 308 (which is an example of an altered aspect of operation of the aircraft) based on the average holding time at the destination airport at the current time, for example. The control unit 102 can then present the recommended airspeed 308, which is determined to reduce a holding time for the aircraft 104 as it is flown to the destination airport.

The airspeed is one aspect that can be altered based on the average holding time in relation to the destination airport. The control unit 102 can also present indicators for various other aspects, such as altitude, flight path, and/or the like.

Referring to FIGS. 1-4, in at least one example, the control unit 102 presents the average holding time trend, along with an estimated fuel burn for the original schedule and one or more different schedule options. The average holding times can be predicted values determined from historical flight data, and/or from previously flown aircraft (such as within an average last 2 hours).

An operator of an aircraft 104 uses the system 100 before departing from a departure airport to determine chances of delayed or early departure to avoid excess holding time. Additionally, the operator can use the system 100 during a flight, such as during a cruise phase of flight, to determine an optimal airspeed to reduce holding time at the arrival airport.

Providing the holding time trend with associated fuel consumption (for example, burn), and optionally airspeed advisories helps operators select an option that reduces a holding time, and arrive at the arrival airport at an acceptable time. The systems and methods described herein increase operational efficiency.

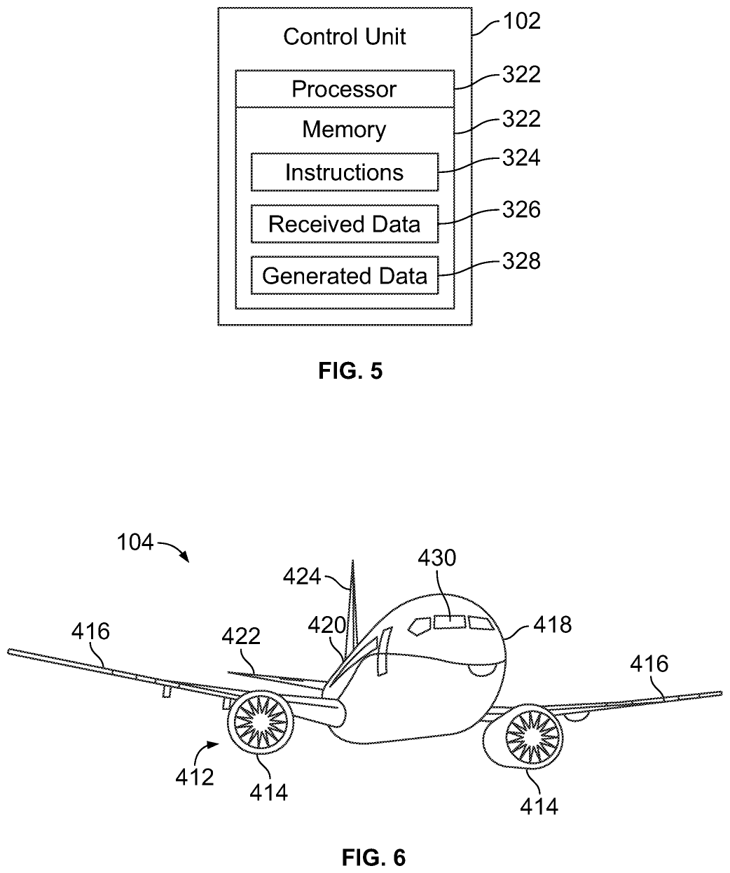

FIG. 5 illustrates a schematic block diagram of the control unit 102, according to an example of the present disclosure. In at least one example, the control unit 102 includes at least one processor 320 in communication with a memory 322. The memory 322 stores instructions 324, received data 326, and generated data 328. The control unit 102 shown in FIG. 5 is merely exemplary, and non-limiting.

As used herein, the term “control unit,” “central processing unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the control unit 102 may be or include one or more processors that are configured to control operation, as described herein.

The control unit 102 is configured to execute a set of instructions that are stored in one or more data storage units or elements (such as one or more memories), in order to process data. For example, the control unit 102 may include or be coupled to one or more memories. The data storage units may also store data or other information as desired or needed. The data storage units may be in the form of an information source or a physical memory element within a processing machine.

The set of instructions may include various commands that instruct the control unit 102 as a processing machine to perform specific operations such as the methods and processes of the various examples of the subject matter described herein. The set of instructions may be in the form of a software program. The software may be in various forms such as system software or application software. Further, the software may be in the form of a collection of separate programs, a program subset within a larger program, or a portion of a program. The software may also include modular programming in the form of object-oriented programming. The processing of input data by the processing machine may be in response to user commands, or in response to results of previous processing, or in response to a request made by another processing machine.

The diagrams of examples herein may illustrate one or more control or processing units, such as the control unit 102. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the control unit 102 may represent processing circuitry such as one or more of a field programmable gate array (FPGA), application specific integrated circuit (ASIC), microprocessor(s), and/or the like. The circuits in various examples may be configured to execute one or more algorithms to perform functions described herein. The one or more algorithms may include aspects of examples disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

Referring to FIGS. 1-5, examples of the subject disclosure provide systems and methods that allow large amounts of data to be quickly and efficiently analyzed by a computing device. For example, the control unit 102 can analyze various aspects of numerous aircraft 104 during a particular time period. As such, large amounts of data, which may not be readily discernable by human beings, are being tracked and analyzed. The vast amounts of data are efficiently organized and/or analyzed by the control unit 102, as described herein. The control unit 102 analyzes the data in a relatively short time in order to quickly and efficiently determine holding times, different schedule options, adaptable aspects, and the like for various aircraft. As such, examples of the present disclosure provide increased and efficient functionality, and vastly superior performance in relation to a human being analyzing the vast amounts of data.

In at least one example, components of the system 100, such as the control unit 102, provide and/or enable a computer system to operate as a special computer system for determining holding times, different schedule options, and alterable flight aspects. The control unit 102 improves upon standard computing devices by determining such information in an efficient and effective manner.

In at least one example, all or part of the systems and methods described herein may be or otherwise include an artificial intelligence (AI) or machine-learning system that can automatically perform the operations of the methods also described herein. For example, the control unit 102 can be an artificial intelligence or machine learning system. These types of systems may be trained from outside information and/or self-trained to repeatedly improve the accuracy with how data is analyzed to determine holding time, schedule options, alterable flight aspects, and the like. Over time, these systems can improve by determining and communicating with increasing accuracy and speed, thereby significantly reducing the likelihood of any potential errors. For example, the AI or machine-learning systems can learn and determine models, and associate such models with holding times, schedule options, alterable flight aspects, and the like. The AI or machine-learning systems described herein may include technologies enabled by adaptive predictive power and that exhibit at least some degree of autonomous learning to automate and/or enhance pattern detection (for example, recognizing irregularities or regularities in data), customization (for example, generating or modifying rules to optimize record matching), and/or the like. The systems may be trained and re-trained using feedback from one or more prior analyses of the data, ensemble data, and/or other such data. Based on this feedback, the systems may be trained by adjusting one or more parameters, weights, rules, criteria, or the like, used in the analysis of the same. This process can be performed using the data and ensemble data instead of training data, and may be repeated many times to repeatedly improve the determinations and communications described herein. The training minimizes conflicts and interference by performing an iterative training algorithm, in which the systems are retrained with an updated set of data, and based on the feedback examined prior to the most recent training of the systems. This provides a robust analysis model that can better determine holding times, schedule options, alterable flight aspects, and the like in a cost effective and efficient manner.

FIG. 6 illustrates a perspective front view of an aircraft 104, according to an example of the present disclosure. The aircraft 104 includes a propulsion system 412 that includes engines 414, for example. Optionally, the propulsion system 412 may include more engines 414 than shown. The engines 414 are carried by wings 416 of the aircraft 104. In other examples, the engines 414 may be carried by a fuselage 418 and/or an empennage 420. The empennage 420 may also support horizontal stabilizers 422 and a vertical stabilizer 424. The fuselage 418 of the aircraft 104 defines an internal cabin 430, which includes a flight deck or cockpit, one or more work sections (for example, galleys, personnel carry-on baggage areas, and the like), one or more passenger sections (for example, first class, business class, and coach sections), one or more lavatories, and/or the like. FIG. 6 shows an example of an aircraft 104. It is to be understood that the aircraft 104 can be sized, shaped, and configured differently than shown in FIG. 6.

Further, the disclosure comprises examples according to the following clauses:

Clause 1. A system comprising:
a control unit configured to:
   determine an average holding time in relation to an arrival airport where an aircraft is scheduled to arrive; and
   determine one or more different schedule options for the aircraft based on the average holding time, wherein the one or more different schedule options differ in at least one respect from an original schedule.

Clause 2. The system of Clause 1, wherein the aircraft is operated according to the one or more different schedule options.

Clause 3. The system of Clauses 1 or 2, further comprising a user interface including a display, wherein the control unit is configured to present the one or more different schedule options on the display.

Clause 4. The system of Clause 3, wherein the user interface is onboard the aircraft.

Clause 5. The system of any of Clauses 1-4, wherein the control unit is further configured to automatically select the one or more different schedule options for the aircraft.

Clause 6. The system of any of Clauses 1-5, wherein the control unit is further configured to automatically operate the aircraft according to the one or more different schedule options.

Clause 7. The system of any of Clauses 1-6, wherein the control unit is further configured to determine one or more alterations to one or more aspects of the aircraft during flight based on the average holding time.

Clause 8. The system of Clause 7, wherein the one or more aspects comprise airspeed.

Clause 9. The system of Clauses 7 or 8, wherein the control unit is further configured to present one or more indicators on a display, wherein the one or more indicators show the one or more alterations.

Clause 10. The system of any of Clauses 1-9, wherein the control unit is an artificial intelligence or machine learning system.

Clause 11. A method comprising: determining, by a control unit, an average holding time in relation to an arrival airport where an aircraft is scheduled to arrive; and determining, by the control unit, one or more different schedule options for the aircraft based on the average holding time, wherein the one or more different schedule options differ in at least one respect from an original schedule.

Clause 12. The method of Clause 11, further comprising operating the aircraft according to the one or more different schedule options.

Clause 13. The method of Clauses 11 or 12, further comprising a user interface including a display, wherein the control unit is configured to present the one or more different schedule options on the display.

Clause 14. The method of Clause 13, wherein the user interface is onboard the aircraft.

Clause 15. The method of any of Clauses 11-14, further comprising automatically selecting, by the control unit, the one or more different schedule options for the aircraft.

Clause 16. The method of any of Clauses 11-15, further comprising automatically operating, by the control unit, the aircraft according to the one or more different schedule options.

Clause 17. The method of any of Clauses 11-16, further comprising determining, by the control unit, one or more alterations to one or more aspects of the aircraft during flight based on the average holding time.

Clause 18. The method of Clause 17, wherein the one or more aspects comprise airspeed.

Clause 19. The method of Clauses 17 or 18, further comprising presenting, by the control unit, one or more indicators on a display, wherein the one or more indicators show the one or more alterations.

Clause 20. A non-transitory computer-readable storage medium comprising executable instructions that, in response to execution, cause one or more control units comprising a processor, to perform operations comprising:
determining an average holding time in relation to an arrival airport where an aircraft is scheduled to arrive;
determining one or more different schedule options for the aircraft based on the average holding time, wherein the one or more different schedule options differ in at least one respect from an original schedule;
presenting the one or more different schedule options on a display of the aircraft;
determining one or more alterations to one or more aspects of the aircraft during flight based on the average holding time; and
presenting one or more indicators on a display, wherein the one or more indicators show the one or more alterations.

As described herein, examples of the present disclosure provide systems and methods for reducing holding times for aircraft. Further, examples of the present disclosure provide systems and methods for increasing operational efficiency of an aircraft.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A system comprising:
a control unit configured to:
determine an average holding time in relation to an arrival airport where an aircraft is scheduled to arrive; and
determine one or more different schedule options for the aircraft based on the average holding time, wherein the one or more different schedule options differ in at least one respect from an original schedule.

2. The system of claim 1, wherein the aircraft is operated according to the one or more different schedule options.

3. The system of claim 1, further comprising a user interface including a display, wherein the control unit is configured to present the one or more different schedule options on the display.

4. The system of claim 3, wherein the user interface is onboard the aircraft.

5. The system of claim 1, wherein the control unit is further configured to automatically select the one or more different schedule options for the aircraft.

6. The system of claim 1, wherein the control unit is further configured to automatically operate the aircraft according to the one or more different schedule options.

7. The system of claim 1, wherein the control unit is further configured to determine one or more alterations to one or more aspects of the aircraft during flight based on the average holding time.

8. The system of claim 7, wherein the one or more aspects comprise airspeed.

9. The system of claim 7, wherein the control unit is further configured to present one or more indicators on a display, wherein the one or more indicators show the one or more alterations.

10. The system of claim 1, wherein the control unit is an artificial intelligence or machine learning system.

11. A method comprising:
determining, by a control unit, an average holding time in relation to an arrival airport where an aircraft is scheduled to arrive; and
determining, by the control unit, one or more different schedule options for the aircraft based on the average holding time, wherein the one or more different schedule options differ in at least one respect from an original schedule.

12. The method of claim 11, further comprising operating the aircraft according to the one or more different schedule options.

13. The method of claim 11, further comprising a user interface including a display, wherein the control unit is configured to present the one or more different schedule options on the display.

14. The method of claim 13, wherein the user interface is onboard the aircraft.

15. The method of claim 11, further comprising automatically selecting, by the control unit, the one or more different schedule options for the aircraft.

16. The method of claim 11, further comprising automatically operating, by the control unit, the aircraft according to the one or more different schedule options.

17. The method of claim 11, further comprising determining, by the control unit, one or more alterations to one or more aspects of the aircraft during flight based on the average holding time.

18. The method of claim 17, wherein the one or more aspects comprise airspeed.

19. The method of claim 17, further comprising presenting, by the control unit, one or more indicators on a display, wherein the one or more indicators show the one or more alterations.

20. A non-transitory computer-readable storage medium comprising executable instructions that, in response to execution, cause one or more control units comprising a processor, to perform operations comprising:
determining an average holding time in relation to an arrival airport where an aircraft is scheduled to arrive;
determining one or more different schedule options for the aircraft based on the average holding time, wherein the one or more different schedule options differ in at least one respect from an original schedule;
presenting the one or more different schedule options on a display of the aircraft;
determining one or more alterations to one or more aspects of the aircraft during flight based on the average holding time; and
presenting one or more indicators on a display, wherein the one or more indicators show the one or more alterations.
